(19) United States
(12) Patent Application Publication
(10) Pub. No.: US 2006/0028985 A1
(43) Pub. Date: Feb. 9, 2006

(54) Topology handler

(75) Inventor: Michael Frantz, Munchen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/142,717

(22) Filed: Jun. 1, 2005

(30) Foreign Application Priority Data
Jun. 1, 2004 (EP) 04012938.9

(51) Int. Cl. H04L 12/26

(52) U.S. Cl. 370/230

(57) ABSTRACT

For the purpose of linking several management applications OLM, ETM, NML, EM of an operations system OS, a central topology handler TPG, which knows about at least some of the assignments of resources TP, CC, CON, PATH, VLAN of a communications network KN to the applications, is introduced. Through the mediation of the topology handler, inquiries about resources are communicated to the application A responsible in each case.

### CROSS REFERENCE TO RELATED APPLICATIONS

This application claims priority to the European application No. 04012938.9, filed Jun. 1, 2004 and which is incorporated by reference herein in its entirety.

### FIELD OF INVENTION

The invention is related to a topology handler.

### SUMMARY OF THE INVENTION

The ITU-T's international standard M.3010 (02/2000) describes a reference architecture for a telecommunications management network (TMN), for monitoring and controlling a network for telecommunications applications, which starts from the assumption that the network controlled by the TMN incorporates different types of network elements, which are usually controlled with the help of different communications mechanisms (e.g. protocols, messages, items of management information—also referred to as an object model).

This TMN incorporates the following functionalities:
Operations Systems Function (OSF), which realizes the “actual” management of the telecommunications network.
Workstation Function (WSF), which is used for displaying the control operations and the network status for a human user of the TMN.
Network Element Function (NEF), which represents an interface for controlling the telecommunications functions of the network elements. This interface defines the specific communications mechanism of the network element concerned, which is not necessarily standardized. The sum of all the items of management information for the NE is referred to as the management information base (MIB) of the NE. It is also referred to below as the NE-MIB.
Transformation Function (TF), which is used for linking components with different communications mechanisms and, in particular, for connecting elements which do not have a standardized NEF into the TMN network. In the M.3010 standard (05/96) it is also referred to as the Mediation Function or the Q-Adaption Function, as applicable.

Physically, the NEF function is usually arranged in a network element (NE), while the OSF and WSF functions are usually realized in a so-called Operations System (OS). Between the NE and the OS, there can be a Data Communications Network (DCN) for communicating data items. This communication follows the principles of the transport service, as described in the four lowest layers of the ISO/OSI reference model in the X.200 international standard.

In up-to-date TMN systems, the individual TMN functions are usually effected by function-specific programs—also called applications. They are executed by hardware (e.g. a processor, I/O module), provided in the installations. Their execution is supported by support software (e.g. a multitasking or multithreading operating system, as applicable, database system, windowing system).

Usually, numerous NEs are assigned to an OS, or to its applications, as appropriate. In this situation, the OS is generally centrally located, while the NEs are distributed locally in the network at numerous sites.

For the purpose of controlling the NEs in a communications network, an OS generally incorporates several management applications, by which different network technologies are controlled. In this situation, each of the individual management applications models visualizes and controls one application-specific subset of the resources of the network, relevant for the technology which is being controlled.

Between the subsets there are dependencies, which frequently take the form of overlying layers. For example, the network layer of a network is arranged above the transmission layer. The transmission layer offers to the network layer such transmission services as 2 Mbps fixed lines between two node points in the network, which are used by the network layer in realizing network services such as for example simple telephone calls (POTS, Plain Old Telephone Service) or value-added services (IN, Intelligent Network).

Building on these, it is possible to provide, for example, a Virtual Local Area Network (VLAN) service to link several distributed local networks (LANs, Local Area Networks), which for this purpose makes use of either a network layer, direct use of a transmission service or use of a service in another layer.

With an architecture which is layered in this way, services in the individual layers which depend on one another are in each case activated upward from below, so that when a service in a higher layer is activated the service which it uses from the next lower layer has in each case already been activated and is ready for use.

On the management application side, this process is supported in that as a first step the service in the lower layer is activated by means of a management application which is assigned to this layer. Following this the service is offered and used by a second management application, for the purpose of activating a service in a higher layer.

For example, if the network is extended by the addition of new optical transmission network elements, the first step is the activation of the new network elements which have been incorporated into the network, using an element manager EM application. Following this, the network elements which have been activated are used by an optical link manager application OLM to activate high bit rate optical links, which (also) pass along the new network elements.

At this point, the new optical links are used by a network management layer NML application for the purpose of activating low bit rate end-to-end (e2β) fixed lines. The activation of further services now follows the same pattern. For example, the new low bit rate fixed lines could be used for the purpose of activating network services, or the new high bit rate ones for activating VLAN services.

From the above explanation it is clear that, due to the strongly distributed nature of the system and the large number of different system components and requirements, the conversion of the architecture described into concrete solutions presents technical problems of a high degree.

It is the object of the invention to recognize at least one of the problems which exist and to solve it by specifying at least one approach to handling it technically.

The invention is based on recognition of the following:
The second management applications on the higher layers are usually informed manually about the activation of a service on a lower layer, using configuration commands. Only after this supply of information is the new service known in the second application, and can from this time point be offered and used by the second application to activate services on the higher layers. Defining the topological view of a network in the individual management applications therefore requires substantial operational effort, which requires in addition detailed knowledge of the structure of the network and the services which have been activated in the network (e.g. switched connections), and is error-prone.
Dynamic operations in the network, such as the insertion or removal of individual network resources (e.g. network elements, modules, services), must be manually synchronized between the individual applications. This calls for not only a high level of discipline in the recording of the data which is to be configured but also a systematic method of working, in which the changes are first collected together, and are only passed on when a sufficient number of data items have been found and, in particular, an appropriate time point. Although this systematic approach does reduce the probability of errors in the configuration of the different applications, it also makes the overall system slow and cumbersome in relation to changes.
In up-to-date operations systems, the topology of the network structure is input into and administered in each management application separately. In this process, the view which is to be input is dependent on both the technologies (e.g. a segment of the transmission or network layer) which a management application can operate and also on the configurations (e.g. new paths or network elements in the next lower layer) which can be effected in the network using other management applications. If a new link has been configured in the network using a management system A, then this fact must be input manually, using individual configuration commands, into those management applications which make use of this link as a basis for further configurations within their layer.
In order to be able to operate and control a communications network consisting of several different topologies, the user must make the network topology known to all the management applications. A management application's view is then defined by the technology which can be operated with a system.
The individual applications often control spatially restricted parts of a particular layer. These are also referred to as ‘domains’. The physical links which are arranged within a domain (lines, channels) are generally known to the application. However, this does not apply for the physical links between different domains within a layer. These are often not modeled by any of the domain-specific applications, because each of these applications is lacking the network resources of the neighboring domain, located in each case at the other end of the link, for a complete model of this physical interdomain link. For a complete representation of an e2e view of this layer, interdomain links can for example be held in a special umbrella application. The consequence is that the physical links for a layer are frequently distributed across numerous domain-specific applications, and generally at least one umbrella application.
These problems also exist in a comparable way for services such as fixed lines, because each domain-specific application sees and monitors only a segment of the complete e2e service, but not however the physical interdomain link.

The patent claims specify a solution for this problem situation, as recognized by the invention, together with advantageous embodiments of this solution.

This solution has numerous associated advantages, which are described in the exemplary embodiments of the invention.
The automatic setting up of a topological view of the communications network for the management applications means that the physical topology of the complete network is only input once by the user. The physical network topology is recorded once in a central topology handler. The applications query the topology handler either for the data (e.g. interdomain links) required for their own functions (e.g. topological view, service structure), or for the applications from which the required data is available (e.g. ports, services of a lower layer), as applicable.
By the immediate supply of information about those resources which are assigned to the topology handler, it is advantageously possible to combine the acknowledgement and renewed inquiry by the requesting application about the resources of the topology handler into one step.
The loading of the topological view into a management application can, by an appropriate filtering of the data which is reported back, be effected flexibly, in one step or several.
By using as a basic filter the transmission layers which can be operated by a management application, the search space for the necessary resources can effectively be restricted to a search space which is relevant for the query concerned. To increase efficiency and accuracy, this filter can be flexibly enhanced as required, by the addition of other object types such as network elements, ports, termination points, physical and/or logical links, services such as paths which are connected in the network and other logical objects.
By the use of a generic solution in which a management application, which registers itself with the topology handler in order to load the NEs and objects which it itself requires, announces at the same time which transmission layers it can operate, the topology manager will over time automatically build up and extend a knowledge of which object instances are available in which application or which resources are assigned to which application, as applicable.
This gives financial advantages to a network operator, from a reduction in the OPEX (OPerational EXpenses).
The logical views of the management applications are automatically made available to the user.
The user does not have to distinguish between the physical network and the logical view of the management system to be operated.
The user needs no knowledge of the configuration operations in the network, because the topological view of the individual management applications is automatically synchronized.
Applying the invention calls for no changes in principles from the existing state of the art, but can be incorporated retrospectively as a module—in particular as a modified or additional computer program product. The time point for its realization can be chosen independently of other functions. If the individual layers are decoupled appropriately by the avoidance of bottom-up references, the system can be realized in steps from the lowest level up to the highest.

The invention is explained below by reference to further exemplary embodiments, which are also illustrated in the figures. It is emphasized that the embodiments of the invention outlined are, in spite of their sometimes very precisely detailed representation, only of an exemplary nature and not to be regarded restrictively.

### BRIEF DESCRIPTION OF THE DRAWINGS

FIG. 1 shows an exemplary arrangement incorporating a central Operations System OS with applications A for controlling local elements NE in a communications network KN,

FIG. 2 shows an exemplary assignment of resources NE, TP, CC, CON, PATH, VLAN in the communications network KN to applications A together with relationships between these resources, and

FIGS. 3-7 show an exemplary sequence of activities for the invention in an execution environment of the form shown in the preceding figures.

### DETAILED DESCRIPTION OF THE INVENTION

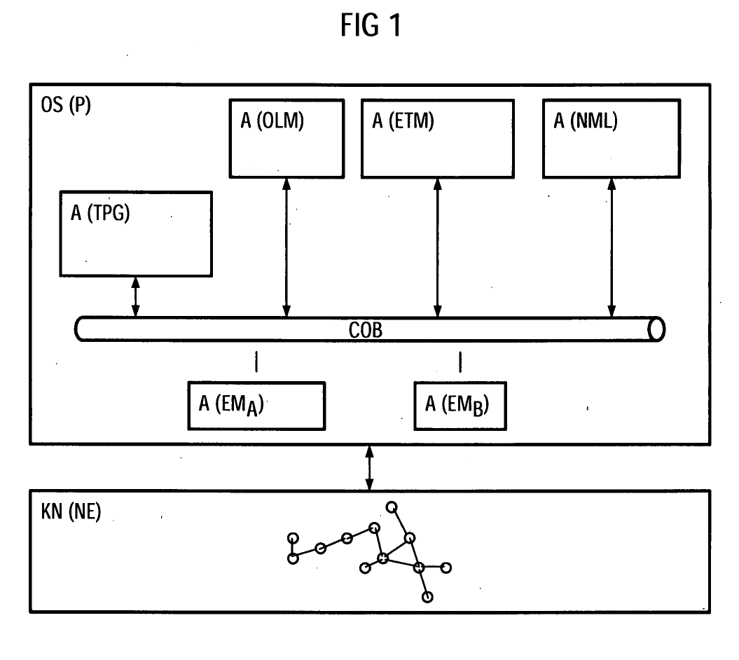

The exemplary embodiments are explained by reference to the arrangement shown in FIG. 1. This arrangement incorporates a central operations system OS with applications A, for controlling local elements NE in a communications network KN, which take the form in particular of a topology handler TPG, optical link manager OLM, network management layer NML, Ethernet manager ETM, or element managers EL_{A}, EM_{B}. To the products, which are in the form of applications A, can be assigned the TMN function blocks Operations Systems Function and Workstation Function, to the products which take the form of network elements NE can be assigned the TMN function block Network Element Function. The applications A are linked to each other by a data network COB. The operations system OS and the network elements NE are linked by a data network known in the technical field as a data communications network (DCN). The products include hardware—in particular processors and storage media—for executing computer program products P, by which the functions are realized.

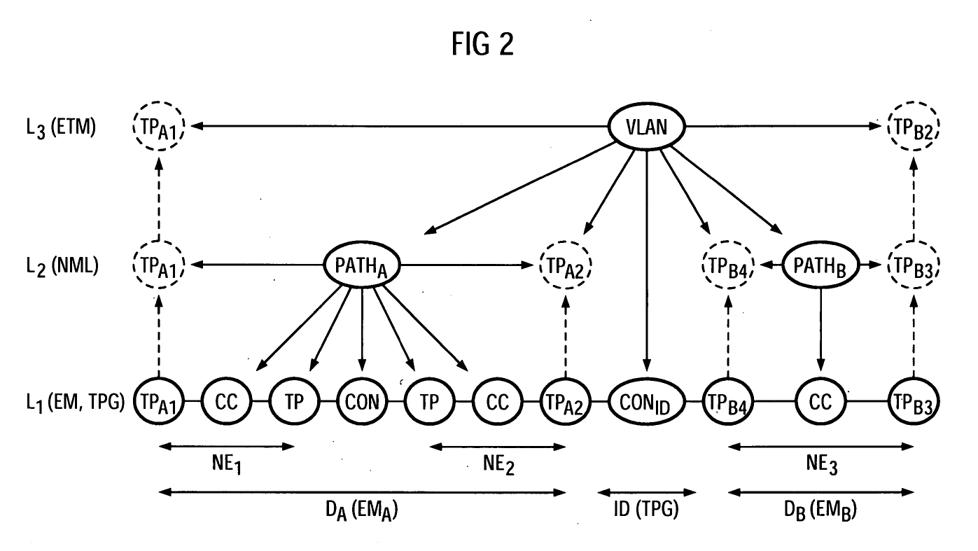

FIG. 2 shows some typical resources of an up-to-date communications network KN. These resources take the form of terminations, for example a termination point TP, cross connection CC, connection CON, fixed line PATH, virtual network link VLAN or network element NE. They are assigned to different applications A, domains D and/or layers L. The resources TP, CC, CON are assigned to the element managers EM, the resource CON_{ID} to the topology handler, the resources PATH to the network management layer NML and the resource VLAN to the Ethernet manager ETM. Also shown is an assignment of the resources to the three layers L₁, L₂, L₃ and to two domains D_{A}, D_{B}.

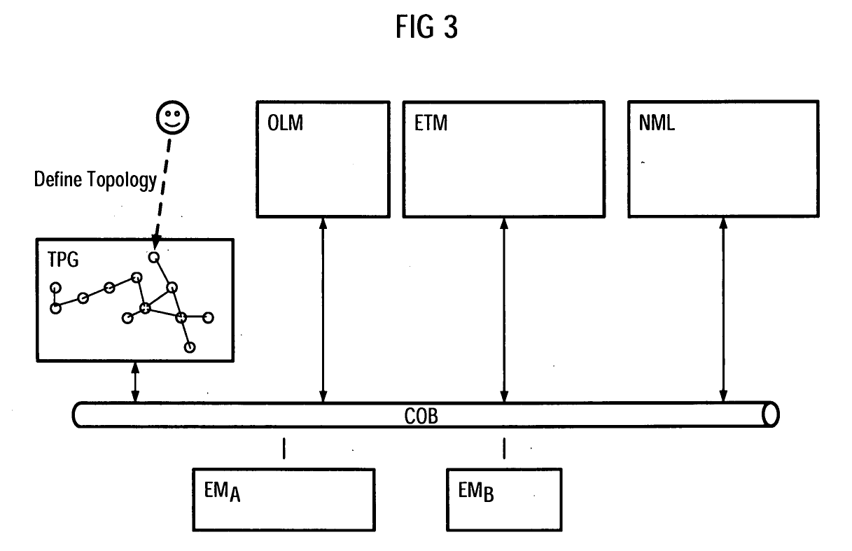

FIGS. 3-7 show a variant embodiment of the invention with a staged inquiry by the Ethernet manager ETM application. The individual steps in the method are shown visually by means of arrows, which stand for the following steps:

FIG. 3 Initially, the topology of the communications network KN is recorded once in the topology handler TPG. This may be effected as shown, for example, by a one-time manual configuration by the network operator. Alternatively, the topology can also be automatically queried by the applications A. This query can, in particular, be made on a step-by-step basis, for example in that information about the resources allocated to the application A is supplied to the topology handler TPG by the applications A when an inquiry is made to the topology handler TPG or during an initial registration with the topology handler TPG.

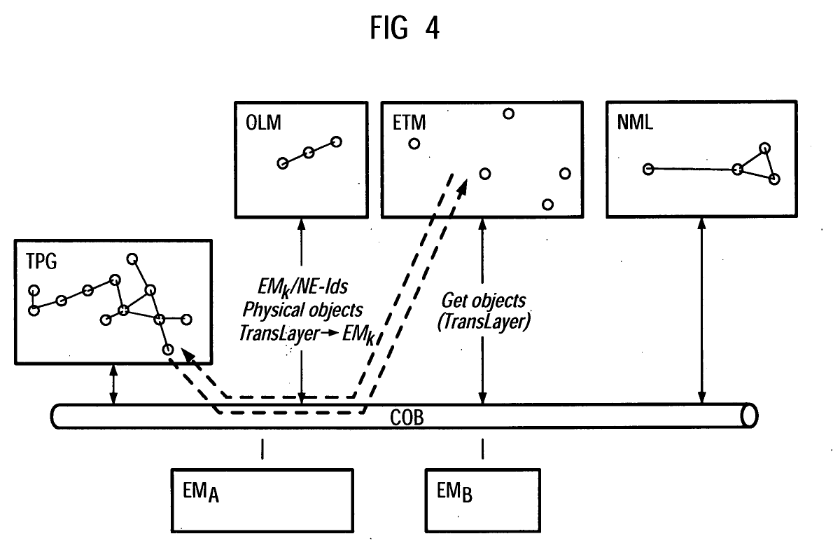

FIG. 4 Then, the network elements NE required for the application ETM are queried on the topology handler TPG, by which a filtered list of network elements NE is supplied back to the inquiring applications ETM.

It is advantageous for e2e applications if transmission layers are used as filters for the structure of the topological network view. To increase efficiency and accuracy, this filter can be flexibly enhanced as required by the addition of other object types, e.g. network elements NE, ports, termination points TP, physical links CON or services such as fixed lines PATH which are connected in the network and other logical objects such as for example virtual network links VLAN.

It is advantageous if the filters are chosen such that the resources about which information is supplied are exactly those which are necessary for the processing of the data requested by the application A making the inquiry. This can be achieved, for example, by an appropriately clear query from the application A, or by taking into account appropriate special knowledge which the topology handler TPG has about the environment of the application A making the inquiry.

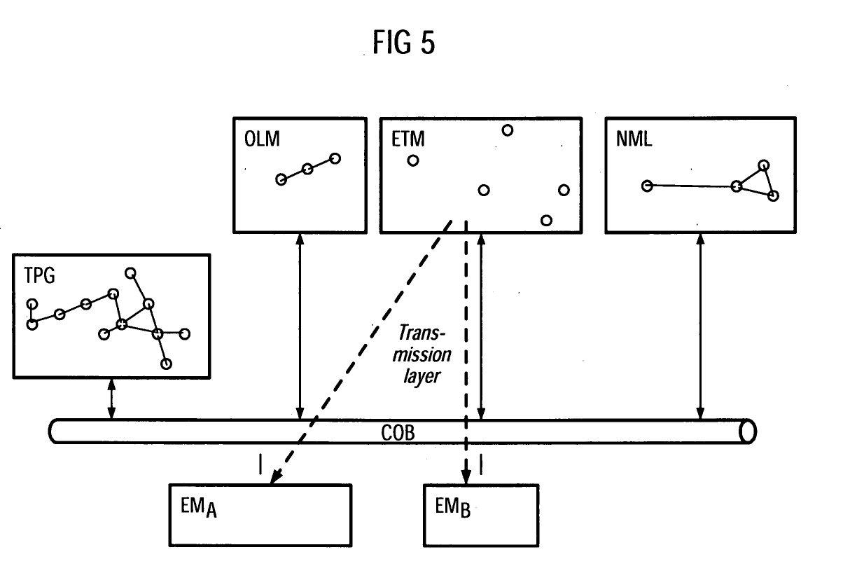

FIG. 5 The element managers EM responsible for the management of the network elements NE specified in this list are queried about the resources.

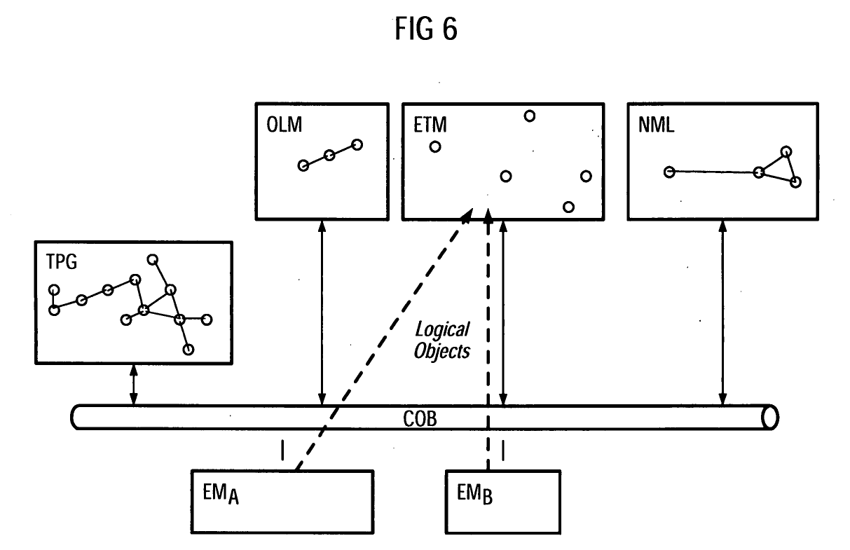

FIG. 6 As the reply, the element managers EM supply information about the resources, or about the object instances/NE objects which represent them, as applicable.

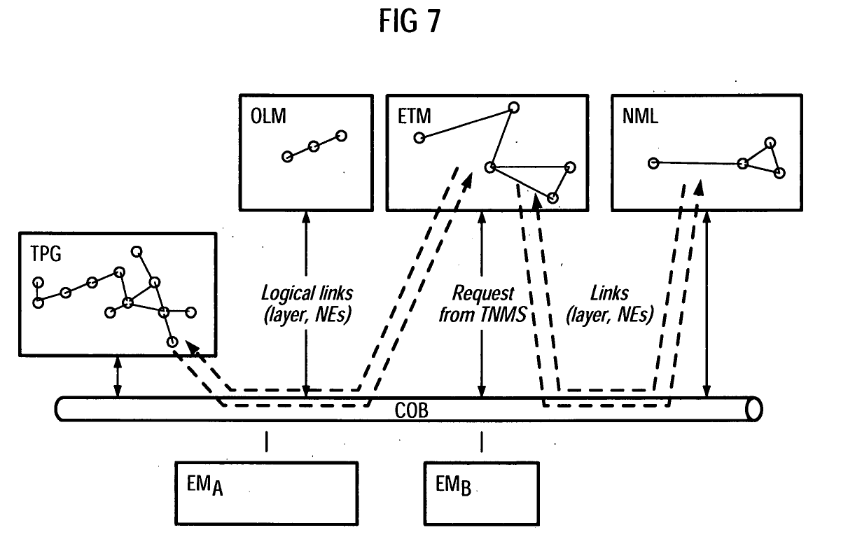

FIG. 7 Following this, links, in particular physical links CON_{ID}, or logical links or fixed lines PATH, as applicable, are requested on the topology handler.

If the requested link corresponds to a physical link CON_{ID} which is assigned to it, the topology handler TPG will service this inquiry directly, for example by supplying information about the resource CON_{ID} assigned to the topology handler TPG.

If a logical transmission layer is involved, the topology handler TPG returns information about which application A has requested the data which is being queried. In this case, the management application ETM making the inquiry retrieves the required data from the management application A (object instance) of which it has been informed.

As soon as all the necessary data is available at the Ethernet manager application ETM, the latter is able to effect the service for which the data is required. This service might be, for example, the automatic generation or synchronization, as applicable, of a topological view of the network, as seen by the Ethernet manager ETM, or the establishment of a virtual network link VLAN.

Obviously, the steps indicated can also be effected with a single query. The realization variant which is chosen will depend on the individual requirements of the application A concerned. If, for example, fast response times are important, one would tend rather towards a step-by-step realization because fewer tasks would then have to be performed in each step. On the other hand, if one would like if possible to have full information from the beginning, the necessary data items would then rather be queried in a single step, because then a fragmented query technique is not necessary.

The invention indicates a generic way in which e2e applications, OML, ETM, NML, can automatically recognize and synchronize the topological network view in a distributed system for the management of communications networks. In this, due to the use of one central component for the definition of the physical network (the topology handler TPG), the remaining components or applications A, as applicable, of the distributed operations system OS need have no knowledge about other components or applications A.

The invention thus ensures that the items of information indicated are always up-to-date, no inconsistent intermediate states are reported, only a limited load is placed on the individual components of the overall system, and hence the stability of the overall system is increased.

In conclusion, it is noted that the description of the system components which are relevant for the invention should not be considered as restrictive in terms of any particular physical realization or assignment. To the appropriate specialist it will be apparent, in particular, that all the products can be realized, partly or fully distributed, in software/computer program products and/or across several physical installations.

1-9. (canceled)

10. A method for linking management applications, wherein a communications network provides a plurality of resources, wherein the resources are at least partially assigned to the applications, wherein a topology handler application is provided, to which the assignments are at least partly known, wherein the linking, when an application requests resources which are not assigned to it, comprises the following steps:
inquiring the topology handler by the application requesting the not assigned resources indicating that an access to the not assigned resources is required;
providing information to the inquiring application by the topology handler about which resources are available from which application; and
requesting at least one of the available resources by the inquiring application.

11. The method in accordance with claim 10, wherein the topology handler directly provides information about resources if they are assigned to the topology handler itself.

12. The method in accordance with claim 11, wherein topology handler directly provides information about interdomain links.

13. The method in accordance with claim 10, wherein the resources are designed as ports, physical or logical links, or services.

14. The method in accordance with claim 11, wherein the resources are ports, physical or logical links, or services.

15. The method in accordance with claim 12, wherein the resources are designed as ports, physical or logical links, or services.

16. The method in accordance with claim 10, wherein information is provided about such resources necessary for handling the inquiry.

17. The method in accordance with claim 11, wherein information is provided about such resources necessary for processing the inquiry.

18. The method in accordance with claim 13, wherein information is provided about such resources necessary for processing the inquiry.

19. The method in accordance with claim 10, wherein the resources are determined by the topology handler using a filter algorithm based on the inquiry and/or the inquiring application.

20. The method in accordance with claim 19, wherein the resources are resources of particular network layers, network elements and/or of a particular nature, such as termination points or ports.

21. The method in accordance with claim 11, wherein the information is provided using a filter algorithm based on the inquiry and/or the inquiring application.

22. The method in accordance with claim 10, wherein the topology handler is informed by the inquiring application about the resources assigned to the inquiring application.

23. The method in accordance with claim 11, wherein the topology handler is informed by the inquiring application about the resources assigned to the inquiring application.

24. A product comprising mechanisms for carrying out the steps of the method in accordance with claim 10.

25. The product in accordance with claim 24, wherein the product is a central controller forming an operations system of a TMN.

26. The product in accordance with claim 24, wherein the product is designed as a computer program product having program code for executing the method steps according to claim 10 by at least one processor.

27. A product, comprising:
mechanisms for carrying out those steps of the method in accordance with claim 10 which are effected by the product; and
mechanisms for carrying out interactions between the product and other products by which the remaining steps of the method in accordance with claim 10 are carried out.

28. The product in accordance with claim 27, wherein the product is a management application or a topology handler application.

29. The product in accordance with claim 27, wherein the product is designed as a computer program product having program code for executing the method steps according to claim 10 by at least one processor.
